(19) United States
(12) Patent Application Publication
(10) Pub. No.: US 2024/0374942 A1
(43) Pub. Date: Nov. 14, 2024

(54) SHUTTLE STOPPER

(71) Applicant: Honeywell Safety Products USA, Inc., Charlotte, NC (US)

(72) Inventors: Stepan Holik, Studenka (CZ); Petr Adamik, Jihlava (CZ); Tanguy Herve Andre Pierre Prevot, Brno (CZ); Radim Drmela, Holubice (CZ)

(21) Appl. No.: 18/313,870

(22) Filed: May 8, 2023

(51) Int. Cl. A62B 35/00

(52) U.S. Cl. CPC A62B 35/0056; A62B 35/0081

(57) ABSTRACT

Various devices, assemblies, components, systems, and methods are provided relating to a shuttle stopper to facilitate alignment of a shuttle with a rail. An example shuttle stopper may include an alignment portion defining an alignment surface configured to face inwardly towards a center axis of the rail. The alignment surface may define a first distance to the center axis. The shuttle stopper may further include a safety portion defining a safety surface configured to face inwardly towards a center axis of the rail on an opposite side of the center axis from the alignment surface. The safety surface may define a second distance to the center axis. The second distance may be greater than the first distance. The shuttle stopper may be configured to rigidly attach to the rail.

### TECHNICAL FIELD

The present disclosure relates to a shuttle stopper capable of facilitating correct positioning of a shuttle on a rail to improve safety when in use by an operator. Various devices, assemblies, and methods are also provided.

### BACKGROUND

Shuttles provide fall protection and important safety mechanisms for workers. Some shuttles may be designed with a particular direction of operation along a rail assembly. In the event the shuttle is positioned incorrectly, the shuttle may fail to operate or otherwise pose a safety risk to the operator. In some instances, shuttles may be used on a variety of rails, such that accurate and correct placement cannot be guaranteed with current systems. Through applied effort, ingenuity, and innovation, Applicant has solved problems relating to shuttles by developing solutions embodied in the present disclosure, which are described in detail below.

### BRIEF SUMMARY

Various embodiments of the present disclosure include shuttle stopper, assemblies, shuttle assemblies, and corresponding systems, devices, components, and methods related to a shuttle stopper device.

Various embodiments of the present disclosure may include a shuttle stopper configured to be attached to a rail to facilitate alignment of a shuttle with the rail. The shuttle stopper may include an alignment portion that defines an alignment surface. The alignment surface may be configured to face inwardly towards a center axis and may define a first distance to the center axis. The shuttle stopper may further include a safety portion that defines a safety surface. The safety surface may be configured to face inwardly towards the center axis on an opposite side of the center axis from the alignment surface. The safety surface may further define a second distance to the center axis. The second distance may be greater than the first distance. The shuttle stopper may be configured to rigidly attach to the rail.

In some embodiments, the shuttle stopper may further comprise an attachment portion configured to secure the shuttle stopper to the rail. In some embodiments, the alignment surface and the safety surface may be configured to intersect a height of a pin of the shuttle. The height of the pin may be configured to be defined perpendicular to a direction of travel of the shuttle. In some embodiments, the second distance may be configured to permit a pin of the shuttle to pass inwardly of the safety surface when a shuttle is in a correctly installed position on the rail. In some embodiments, the alignment portion may be configured to engage with a portion of the shuttle when the shuttle is positioned backwards on the rail.

Various embodiments of the present disclosure may include a shuttle stopper assembly. The shuttle stopper assembly may be configured to be attached to a rail to facilitate alignment of a shuttle with the rail. The shuttle stopper assembly may include a shuttle stopper. The shuttle stopper may include an alignment portion that defines an alignment surface. The alignment surface may be configured to face inwardly towards a center axis and may define a first distance to the center axis. The shuttle stopper may further include a safety portion that defines a safety surface. The safety surface may be configured to face inwardly towards the center axis on an opposite side of the center axis from the alignment surface. The safety surface may further define a second distance to the center axis. The second distance may be greater than the first distance. The shuttle stopper may be configured to rigidly attach to the rail. The shuttle stopper assembly may further include the shuttle comprising a pin. The shuttle may define a direction of travel along the center axis of the rail. The pin may be disposed at a first lateral side of the shuttle.

Various embodiments of the present disclosure may include a shuttle stopper assembly. The shuttle stopper assembly may be configured to be attached to a rail to facilitate alignment of a shuttle with the rail. The shuttle stopper assembly may include a shuttle stopper. The shuttle stopper may include an alignment portion that defines an alignment surface. The alignment surface may be configured to face inwardly towards a center axis and may define a first distance to the center axis. The shuttle stopper may further include a safety portion that defines a safety surface. The safety surface may be configured to face inwardly towards the center axis on an opposite side of the center axis from the alignment surface. The safety surface may further define a second distance to the center axis. The second distance may be greater than the first distance. The shuttle stopper may be configured to rigidly attach to the rail. The shuttle stopper assembly may further include the rail. The rail may define the center axis.

In some embodiments, the shuttle stopper may further comprise an attachment portion. The attachment portion may be configured to secure the shuttler stopper to the rail. In some embodiments, the attachment portion may be further configured to define an axis of the shuttle stopper. The axis of the shuttle stopper may be parallel to the center axis of the rail. The alignment surface and the safety surface may each define planes parallel to the axis of the shuttle stopper.

In some embodiments, the shuttle stopper assembly may further comprise a shuttle comprising a pin. The shuttle may define a direction of travel along the center axis of the rail. The pin may be disposed at a first lateral side of the shuttle. In some embodiments, the pin may protrude from the first lateral side of the shuttle in a direction perpendicular to the direction of travel of the shuttle. In some embodiments, the alignment surface and the safety surface may be configured to intersect a height of the pin. The height may be measured perpendicular to a direction of travel of the shuttle. In some embodiments, the second distance may be greater than a pin distance of the shuttle. The pin distance may be measured from the center axis of the rail to the end of a pin of the shuttle. In some embodiments, the pin of the shuttle may be configured to pass inwardly of the safety surface when the shuttle is installed correctly on the rail. In some embodiments, the alignment portion may be configured to engage with at least a portion of the shuttle when the shuttle is positioned backwards on the rail.

Various embodiments may include a method of operating a shuttle with a rail having a shuttle stopper. The method may include sliding a shuttle along a rail. The rail may have a shuttle stopper. The shuttle stopper may include an alignment portion that defines an alignment surface. The alignment surface may be configured to face inwardly towards a center axis and may define a first distance to the center axis. The shuttle stopper may further include a safety portion that defines a safety surface. The safety surface may be configured to face inwardly towards the center axis on an opposite side of the center axis from the alignment surface. The safety surface may further define a second distance to the center axis. The second distance may be greater than the first distance. The shuttle stopper may be configured to rigidly attach to the rail. The pin of the shuttle may be configured to pass inwardly of the safety surface when the shuttle is in a correctly installed position on the rail.

In some embodiments, the alignment surface and the safety surface may be configured to intersect a height of a pin of the shuttle. The height may be configured to be defined perpendicular to a direction of travel of the shuttle. In some embodiments, the second distance may be configured to be greater than a pin distance of the shuttle. The pin distance may be measured from the center axis of the rail to a top of a pin of the shuttle. In some embodiments, the safety surface may be configured to permit a pin of the shuttle to pass inwardly of the safety surface when the shuttle is in a correctly installed position on the rail, and the alignment portion may be configured to engage with at least a portion of the shuttle when the shuttle is positioned backwards on the rail.

The above summary is provided merely for purposes of summarizing some example embodiments, to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses may potential embodiments in addition to those here summarized, some of which will be further described below. Other features, aspects, and advantages of the subject matter will become apparent from the description, the drawings, and the claims.

### BRIEF DESCRIPTION OF THE FIGURES

The following drawings are illustrations of a particular embodiment of the present disclosure and therefore do no limit the scope of the present disclosure. The drawings are not necessarily drawn to scale and are intended for use in conjunction with the explanation in the following detailed description.

FIG. 1 illustrates a front view of an example shuttle stopper assembly in accordance with various embodiments of the present disclosure;

FIG. 2 illustrates a front view of an example shuttle stopper assembly in accordance with various embodiments of the present disclosure;

FIG. 3 illustrates a front perspective view of an example shuttle in accordance with various embodiments of the present disclosure;

FIG. 4 illustrates a side view of an example shuttle in accordance with various embodiments of the present disclosure;

FIG. 5 illustrate a side perspective view of an example shuttle in accordance with various embodiments of the present disclosure;

FIG. 6A illustrates a perspective view of an example shuttle stopper in accordance with various embodiments of the present disclosure;

FIG. 6B illustrates a top view of an example shuttle stopper assembly in accordance with various embodiments of the present disclosure;

FIG. 7A illustrates a top view of an example shuttle stopper and rail in accordance with various embodiments of the present disclosure;

FIG. 7B illustrates a perspective view of an example shuttle stopper in accordance with various embodiments of the present disclosure;

FIG. 8 illustrates a front perspective view of an example shuttle stopper in accordance with various embodiments of the present disclosure;

FIG. 9 illustrates a perspective view of an example shuttle stopper in accordance with various embodiments of the present disclosure;

FIG. 10 illustrates a perspective view of an example shuttle stopper in accordance with various embodiments of the present disclosure; and

FIG. 11 illustrates a perspective view of an example shuttle stopper in accordance with various embodiments of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout.

As used herein, terms of direction such as “front,” “rear,” “top,” etc. are used for explanatory purposes in the examples provided below to describe the relative positions of certain components or portions of components to other components or portions of components described in the particular context indicated and should not be interpreted to require an absolute position relative to other points of reference (e.g., relative to the Earth). As used herein, the term “or” is used in both the alternative and conjunctive sense, unless otherwise indicated. The term “along,” and similarly utilized terms, means near or on, but not necessarily requiring direct contact with a surface or other referenced location. The terms “approximately,” “generally,” and “substantially” refer to within manufacturing and/or engineering design tolerances for the corresponding materials and/or elements unless otherwise indicated. The use of such terms is inclusive of and is intended to allow independent claiming of specific values listed. Thus, use of any such aforementioned terms, or similarly interchangeable terms, should not be taken to limit the spirit and scope of embodiments of the present disclosure.

As used in the specification and the appended claims, the singular form of “a,” “an,” and “the” include plural references unless otherwise stated. The terms “includes” and/or “including,” when used in the specification, specify the presence of stated feature, elements, and/or components; it does not preclude the presence or addition of one or more other features, steps, operations, elements, components, and/or groups thereof.

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Shuttles may be used for a variety of purposes, including fall protection, whereby a user, often working at height, clips themselves to the shuttle. The shuttles may include braking mechanism that may act against a rail to retard the fall of the user under at least some circumstances. In some instances, the braking mechanism may be operable only in a single direction (e.g., “downward” in an embodiment in which the shuttle runs vertically along a vertically arranged rail, with the rail running such that the central axis, discussed hereinafter, is oriented vertically). The shuttle may be attached to a rail along a work area and the user may be harnessed into the shuttle (e.g., via a rope and/or carabiner). The rail may limit movement of the shuttle to a single axis. As described herein, the present disclosure includes various embodiments of a shuttle stopper configured to be attached to a rail to facilitate proper alignment of a shuttle with the rail and/or prevent improper alignment of the shuttle. The shuttle stopper may attach at the mouth of a rail (e.g., one or both ends of the rail) or otherwise adjacent to a location of the rail at which a shuttle is attached. Embodiments of the shuttle stopper may include an alignment portion, which may be configured to contact a portion of the shuttle if the shuttle is misaligned, and a safety portion, which may allow the portion of the shuttle to pass through the shuttle stopper if the shuttle is properly aligned.

In some embodiments, the alignment portion may be positioned closer to the center axis of the rail than the safety portion. The differential in position of the alignment portion and the safety portion may cause an asymmetrical shuttle to impinge on the alignment portion but not the safety portion depending upon which orientation the shuttle is attached to the rail. The shuttle stopper may thereby allow the shuttle to pass and function correctly only in a single orientation.

In some embodiments, the alignment portion may define an alignment surface configured to face inwardly towards a center axis of the rail. In some embodiments, the alignment surface may be further configured to define a first distance to the center axis of the rail. In some embodiments, the safety portion may define a safety surface configured to face inwardly toward the center axis of the rail on an opposite side of the center axis. In some embodiments, the safety surface may be further configured to define a second distance from the center axis. In various embodiments, the second distance is configured to be further from the center axis than the first distance

The alignment portion and/or the safety portion may align with a height of a pin of a shuttle. The pin of the shuttle may protrude from one lateral side of the shuttle to define at least a portion of the asymmetry of the shuttle. The pin may extend from the lateral side perpendicular to the center axis of the rail. In some embodiments, the pin of the shuttle may pass inwardly of a safety surface when the shuttle is correctly installed on the rail. In some embodiments, the pin of the shuttle may contact at least partially the alignment portion when the shuttle is positioned backwards on the rail. The alignment portion may be configured to prevent the shuttle from advancing along the direction of travel past the alignment portion when the shuttle is positioned backwards on the rail.

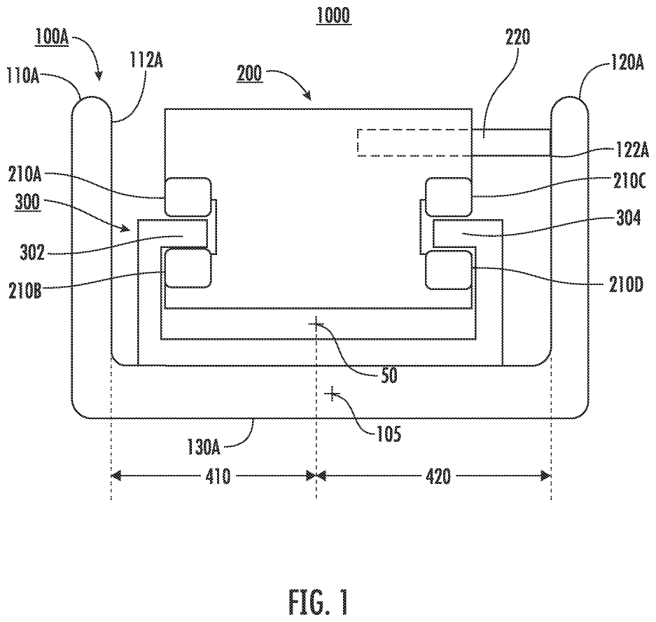

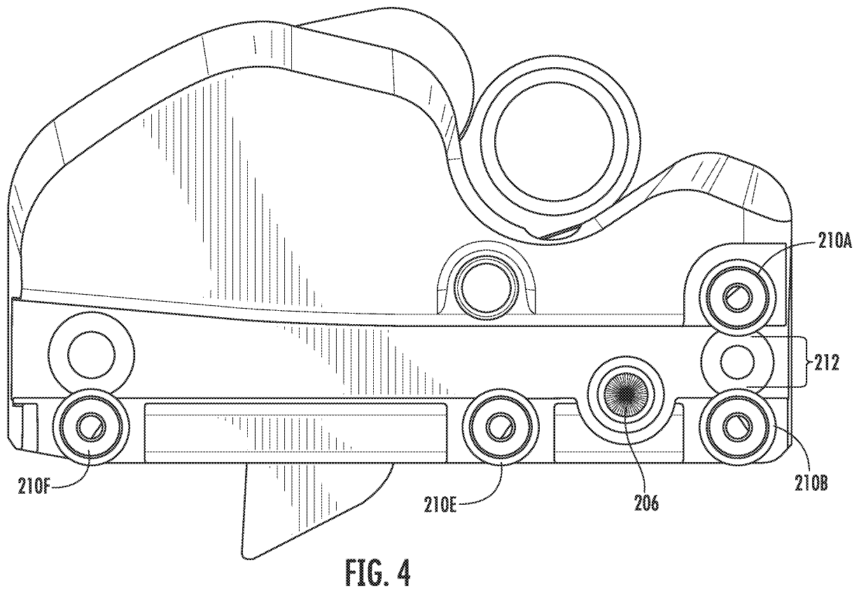

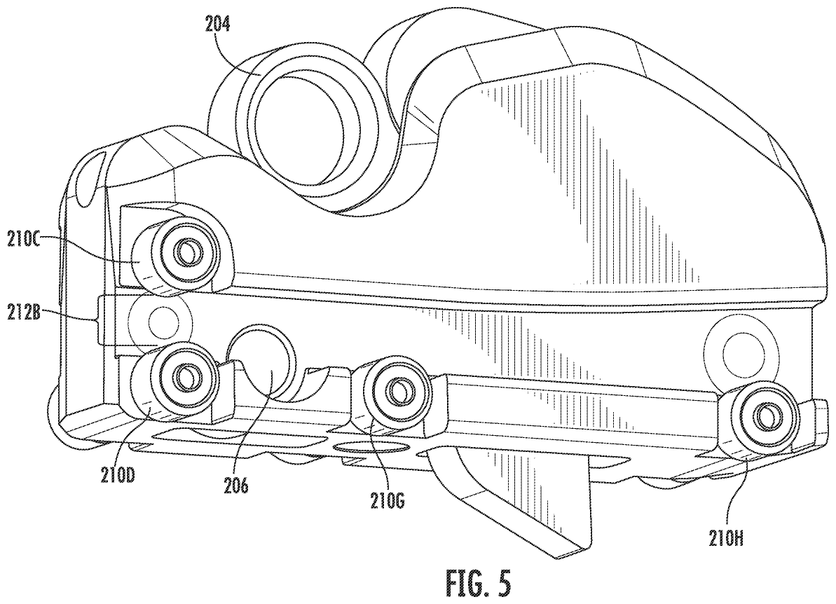

FIGS. 1-11 depict exemplary views of various embodiments of example shuttle stoppers, shuttle stopper assemblies, and portions thereof in accordance with various embodiments of the present disclosure. FIG. 1 depicts a simplified front perspective view of an example shuttle stopper assembly 1000 according to some embodiments of the present disclosure, which in the depicted embodiment includes a shuttle stopper 100A (together with shuttle stoppers 100B, 100C, 100D, 100E, and 100F referred to as “100”), a shuttle 200, and a rail 300. The simplified shuttle stopper 100A illustrates various features used in the examples disclosed herein, which features may be applied to any embodiment in whole or in part. The shuttle stopper 100A may include an alignment portion 110A (together with alignment portions 110B, 110C, 110D, 110E, and 110F referred to as “110”) and a safety portion 120A (together with safety portions 120B, 120C, 120D, 120E, and 120F referred to as “120”). In some embodiments, an attachment portion 130A (together with attachment portions 130B, 130C, 130D, 130E, and 130F referred to as “130”) may extend between the alignment portion 110A and the safety portion 120A and/or may facilitate attaching the shuttle stopper 100A to the rail 300. In any of the embodiments herein, the attachment portion may be omitted and the alignment and safety portions may be attached directly to the rail or to some other substrate (e.g., a wall). The shuttle stopper 100A in the depicted embodiment includes the alignment portion 110A disposed on a first side of a rail 300, the safety portion 120A disposed on a second side of the rail 300, and the attachment portion 130A at least partially contacting the rail 300. In some embodiments, a bolt, pin, or other fastener may be used to secure the shuttle stopper 100A to the rail 300. With continued reference to FIG. 1, the alignment portion 110A may further define an alignment surface 112A (together with alignment surfaces 112B, 112C, 112D, 112E, and 112F referred to as “112”) and/or the safety portion 120A may further define a safety surface 122A (together with safety surfaces 122B, 122C, 122D, 122E, and 122F referred to as “122”). Both the alignment surface 112A and the safety surface 122A are configured to face inwardly towards a center axis 50, described hereinafter, that is defined by the rail 300. The safety surface 122A is disposed on an opposite side of the center axis of the rail relative to the alignment surface 112A. The rail 300 may be mounted in various orientations and configurations in a work environment (e.g., parallel to a vertical ladder, along a sloping or horizontal walkway, etc.) such that the absolute orientation of the shuttle stopper assembly 1000 may vary depending upon the use case.

In various embodiments, the alignment surface 112A may further define a first distance 410 from the center axis of the rail and the safety surface 122A may further define a second distance 420 from the center axis of the rail. The first and second distance are configured to be measured from the center axis of the rail to the relative surfaces. In various embodiments, the second distance is a greater distance than that of the first distance, such that when the shuttle 200 is positioned correctly on the rail, it is allowed to inwardly pass by the safety surface 122A of the safety portion 120A (e.g., pin 220 will clear the inside wall surface of the safety portion 120A). However, when the shuttle 200 is positioned incorrectly (e.g., backwards), the asymmetry of the shuttle at the pin 220 and the asymmetry of the shuttle stopper 100A will cause the pin to contact the alignment portion 110A and not be able to pass by the shuttle stopper 100A. In the depicted embodiments, the height of the pin 220 may be measured from a number of locations (e.g., a base of the shuttle 200, upward-facing surface of the attachment portion 130A, etc.) so long as the respective heights discussed herein are measured consistently. The center axis 50 may be defined by the midpoint of the rail 300, by a predetermined axis along the shuttle stopper 100A, and/or by an axis disposed on a center, vertical plane of the shuttle 200 which is parallel to the direction of travel. The length of the pin 220 may be less than the second distance defined by the safety surface of the shuttle stopper 100A. The shuttle 200, when positioned backwards, is prevented from advancing along the rail 300 by the pin 220 contacting the alignment portion 110A, the alignment surface 112A, and/or a portion thereof.

With further reference to FIG. 1, in various embodiments, the shuttle stopper assembly 1000 may comprise a shuttle 200 movably connected to the rail 300. In various embodiments, the shuttle 200 may include at least one movement element 210A, 210B, 210C, 210D (collectively “210”) and/or at least one pin 220. The movement elements 210 may be rollers, wheels, tracks, balls, etc. The shuttle 200 in the depicted embodiment depicts a first movement element 210A and a third movement element 210C configured to roll or otherwise move along the top surfaces (relative to the orientation of the figures) of corresponding flanges of the rail and a second movement element 210B and fourth movement element 210D configured to roll or otherwise move along the bottom surfaces of the corresponding flanges. The movement elements 210 may assist in translating the shuttle along a direction of travel. The direction of travel may be parallel to the center axis of the rail. The shuttle may further define at least a first lateral side from which the pin 220 may extend. The pin 220 may be an integral portion of the remaining body of the shuttle (e.g., a molded protrusion formed of the same material as one or more other portions of the shuttle body) or the pin 220 may be separately attached to the shuttle whether formed of the same or a different material (e.g., metal, such as steel). The pin 220 may extend laterally from the first lateral side of the shuttle 200. For example, the depicted pin 220 extends perpendicular to the direction of travel and the center axis 50. In various embodiments, the pin 220 may contact the alignment portion 110A at least partially when the shuttle is positioned backwards on the rail to prevent the shuttle from passing the shuttle stopper in the wrong direction (e.g., when the shuttle 200 is installed incorrectly). In a correctly installed position, the pin 220 may pass inwardly along the safety surface of the safety protrusion 120A.

In the depicted embodiment, the rail 300 comprises a first flange 302 and a second flange 304. The flanges 302, 304 may be configured to prevent the depicted shuttle 200 from being removed from the rail by vertically pulling on the shuttle (relative to the orientation shown in the figures). The rail 300 may further comprise at least one hole that may receive a fastener (e.g., bolt, screw, rivet, etc.) to secure the shuttle stopper 100A to the rail. The rail 300 and shuttle stopper 100A may also be connected via other fastening means (e.g., welding, adhesive, etc.). In various embodiments, the rail 300 comprises a plurality of holes spaced a predetermined distance in between each individual hole, whereby multiple fasteners may be used, the location of the shuttle stopper 100A may be adjusted, and/or a plurality of shuttle stoppers may be secured to the rail.

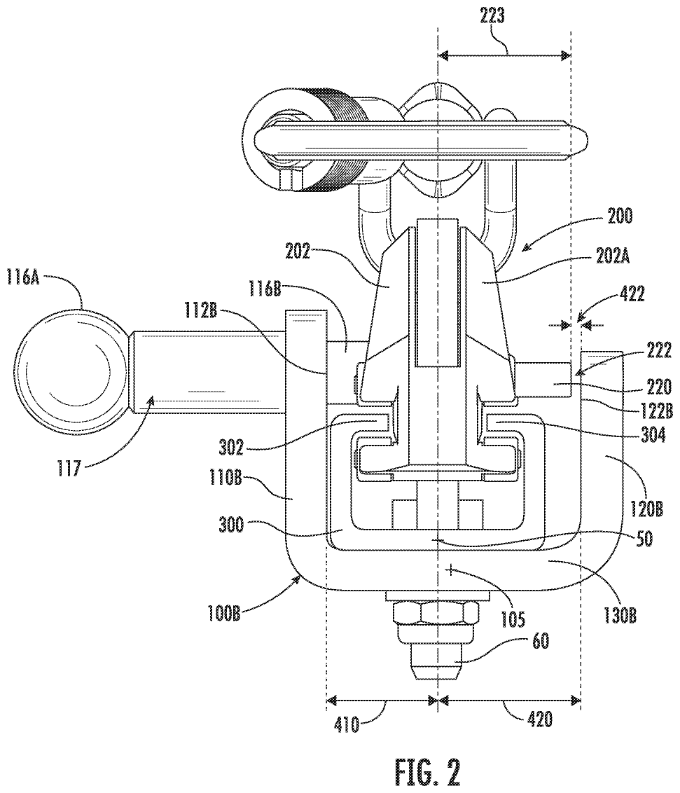

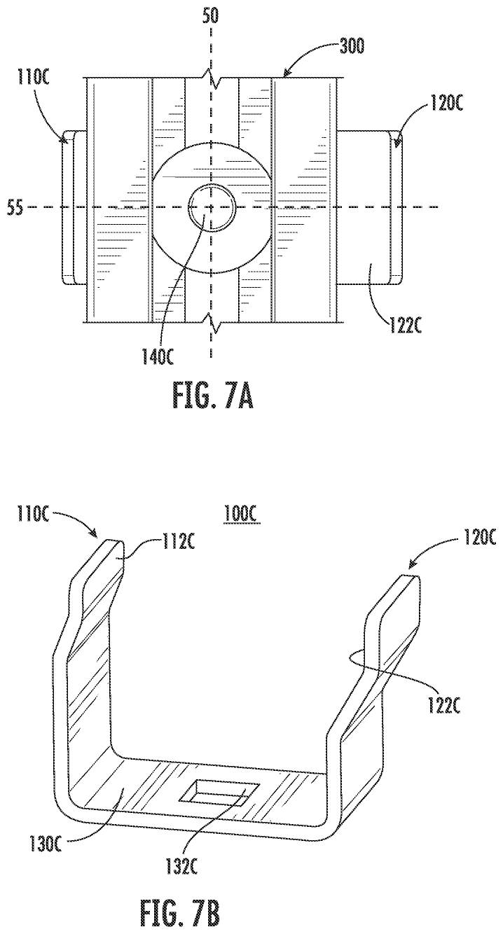

With reference to FIG. 2, in various embodiments, a body 202 of the shuttle 200 may be centered on the center axis 50 relative to the rail 300. The center axis 50 may be a reference from which the first distance 410 and the second distance 420 may be measured. The shuttle stopper 100 may also define a center axis 105 that may, in some embodiments, be parallel to and offset laterally from the center axis 50 of the rail (e.g., to facilitate the difference in first and second distances), such as is shown in FIGS. 1-2. In some embodiments, such as shown in FIGS. 7A-11, the lower portion of the shuttle stopper may be aligned with the rail and the upper portion of the shuttle stopper may be angled in one or more directions.

In the depicted embodiment, the first distance 410 is measured laterally (e.g., within a horizontal plane in the reference frame of the figures) from a lateral position of the center axis 50 to a lateral position the alignment surface of the alignment portion 110B of a shuttle stopper, and the second distance 420 is measured laterally from the center axis 50 to the safety surface 122B of a safety portion 120B of the shuttle stopper. The pin length 223 may be defined in the lateral direction and measured relative to the center axis 50, even if the pin itself extends past or stops short of the center axis. In some embodiments, the pin length 223 may be greater than the first distance 410 and less than the second distance 420. For example, in some embodiments, the pin length 223 may be equal to 32.2 mm. In some embodiments, the pin length 223 may be within 5% (e.g., greater than or equal to 30.59 mm and less than or equal to 33.81 mm) or within 10% (e.g., greater than or equal to 28.98 mm and less than or equal to 35.42 mm) of 32.2 mm. In some embodiments, the pin length 223 may be greater than 22 mm and less than 37 mm. In some embodiments, the first distance 410 may be 22 mm and/or the second distance 420 may be 37 mm. In some embodiments, the first distance 410 may be within 5% (e.g., greater than or equal to 20.9 mm and less than or equal to 23.1 mm) or within 10% (e.g., greater than or equal to 19.8 mm and less than or equal to 24.2 mm) of 22 mm. In some embodiments, the second distance 420 may be within 5% (e.g., greater than or equal to 35.15 mm and less than or equal to 38.85 mm) or within 10% (e.g., greater than or equal to 33.3 mm and less than or equal to 40.7 mm) of 37 mm. By way of example based on the ranges established above, in some embodiments, the pin length may be from 19.8 mm to 40.7 mm or any other combination of maximum and minimum distances. The first distance 410 is configured to be less than the second distance 420 in order to prevent the shuttle from advancing along the direction of travel when installed in an incorrect position (e.g., backwards) on the rail. In the depicted embodiment, the tip of the pin 222 is able to pass inwardly by the safety surface 122B of the safety portion 120B. The tip of the pin 222 and the safety surface may define a gap 422 therebetween. In various embodiments, the height of a pin 220 may be equal to the height of the respective safety surface 122B and alignment surface 112B for measurement purposes (e.g., other parts of the alignment portion 110B and/or safety portion 120B may be at varying lateral distances, such as shown in FIGS. 7A-11, while still defining the measurements noted above).

With further reference to FIG. 2, in various embodiments, the shuttle stopper may further comprise a shuttle stopper pin 116, which may be configured to prevent the shuttle from falling off the rail unintentionally after attachment. The shuttle stopper pin 116 comprises a pull portion 116A and a pin body portion 116B. In various embodiments, the shuttle stopper pin 116 may be a spring-loaded pin, wherein the pin is configured to translate from an engaged position to a disengaged position when a user pulls against the spring force. In various embodiments, an operator may engage with the pull portion 116A of the shuttle stopper pin 116 to translate the pin from the engaged position to the disengaged position, and the shuttle 200 may be allowed to pass the shuttle stopper pin 116 while in the disengaged position. The pin body portion 116B may at least partially engage with a portion of shuttle 200 (e.g., the body 202 of the shuttle) in an instance in which the shuttle stopper pin 116 is in an engaged position. In some embodiments, the pin body portion 116B may prevent the shuttle from sliding off the rail along the direction of travel for the shuttle (e.g., serving as an obstruction that prevents the shuttle from leaving the rail). In some embodiments, the pin body portion 116B may at least partially engage with body 202 of the shuttle preventing the shuttle from moving in a plurality of directions. In the embodiment depicted in FIG. 2, the shuttle stopper pin 116 translates within a sleeve 117, which forms part of the shuttle stopper 100B.

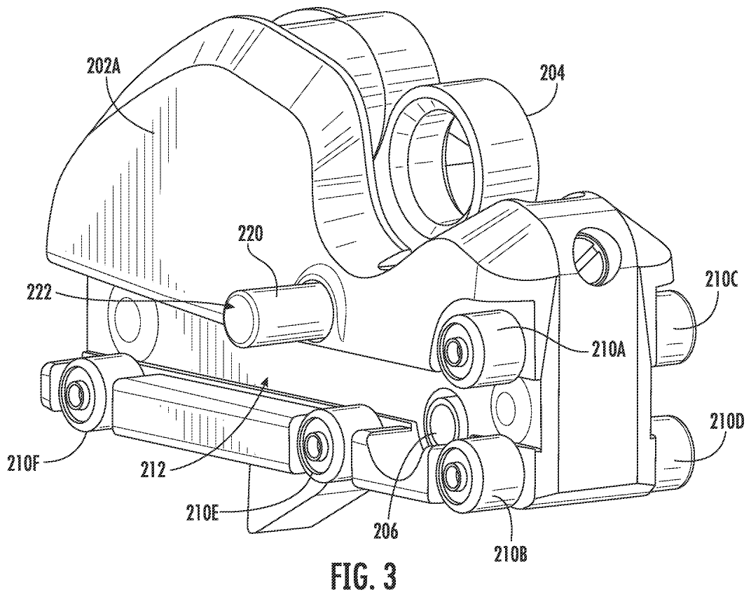

FIGS. 3-5 depict isolated views of the shuttle 200. As depicted, the shuttle 200 defines a shuttle body 202, a pin 220, and optionally at least one movement element 210A, 210B, 210C, 210D, 210E, 210F, 210G, 210F (collectively “210”). More or fewer movement elements may be used than are depicted in FIGS. 3-5. The body 202 may define at least a first lateral side 202A of the shuttle. The pin 220 may extend laterally from within the body 202 of the shuttle perpendicular to the center axis of the rail. The pin 220 may be further configured to extend from the first lateral side 202A of the shuttle 200. In various embodiments, the pin may extend rigidly from the shuttle such that a top of the pin is configured to stay at the same length from the center axis. With reference to FIG. 1, the movement elements 210 may define a first reception slot 212A and a second reception slot 212B into which the flanges 302, 304 insert. The depicted second reception slot 212B is disposed on an opposite side of the body portion of the shuttle relative to the center axis from the first reception slot 212A. The first reception slot 212A may receive at least partially a first flange 302 of the rail, and/or the second reception slot 212B may receive at least partially a second flange 304 of the rail.

With reference to FIGS. 3-5, in various embodiments, the shuttle body 202 may further define at least one pivot point 206 for the shuttle 200. The pivot point 206 may define the location for a shock absorber (e.g., held by a rivet, etc.). The shuttle 200 may further define an attachment portion 204, wherein the attachment portion is configured to receive fall prevention equipment and/or the like.

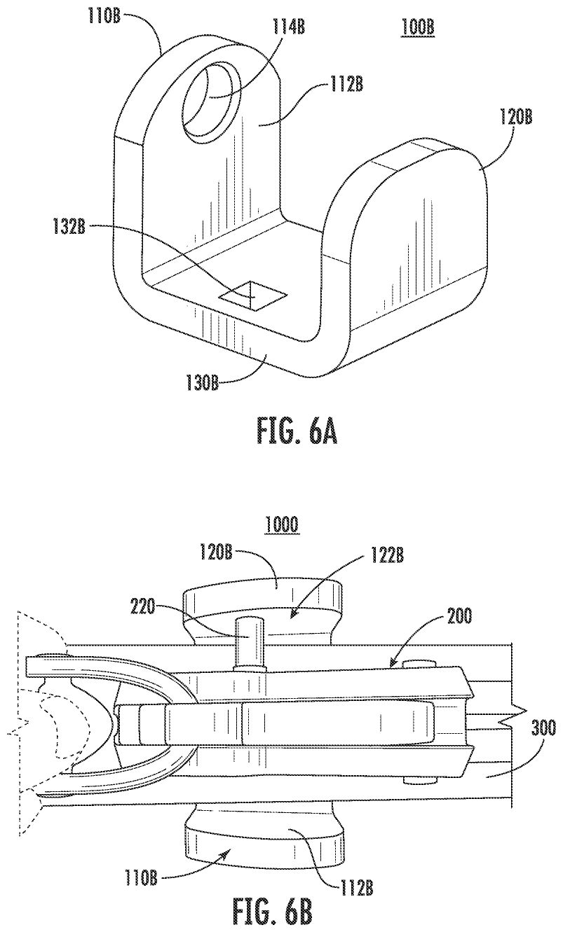

With reference to FIGS. 6A-6B, an example embodiment of a shuttle stopper 100B and shuttle stopper assembly 1000 are depicted. The shuttle stopper 100B may define the alignment portion 110B, the safety portion 120B, and the attachment portion 130B. The depicted alignment portion 110B further defines an alignment surface 112B and/or one or more opening 114B, and the depicted safety portion 120B further defines a safety surface 122B. Both the alignment surface 112B and the safety surface 122B are configured to face inwardly towards a center axis of a rail (e.g., center axis 50 shown in FIG. 2). In various embodiments, the attachment portion 130B may comprise at least one fastener opening 132B to receive at least one fastener 60 (shown in FIG. 2) (e.g., bolts, screws, rivets, etc.) to secure the shuttle stopper 100B to the rail. In some embodiments, the attachment surface may comprise a plurality of fastener openings 132B spaced along the attachment portion 130B to rigidly secure the shuttle stopper 100B to the rail 300. In some embodiments, the attachment portion 130B may be secured to the rail 300 via one or more other attachment means, such as, welding, brazing, riveting, etc.

In various embodiments, the alignment portion 110B may comprise an equal height and/or width to that of the safety portion 120B. In the embodiment depicted in FIG. 6, the alignment portion 110B is taller than the safety portion 120B. In various embodiments, the alignment surface 112B further defines the first distance relative to the center axis defined by the rail, wherein the first distance is perpendicular to the center axis. The opening 114B is defined through the alignment portion 110B of the shuttle stopper 100B and is configured to receive the shuttle stopper pin 116 therethrough.

With reference to FIG. 6B, in various embodiments, the shuttle 200 of the shuttle stopper assembly 1000 is position correctly on the rail 300, allowing the pin 220 to pass inside the safety portion 120B as the shuttle 200 moves along the rail 300. In the depicted embodiments, the pin length 223 (labeled in FIG. 2) is less than the second distance 420 (labeled in FIG. 2) relative to the center axis 50 of the rail 300. The pin 220 can inwardly pass the safety surface 122B while moving along the direction of travel.

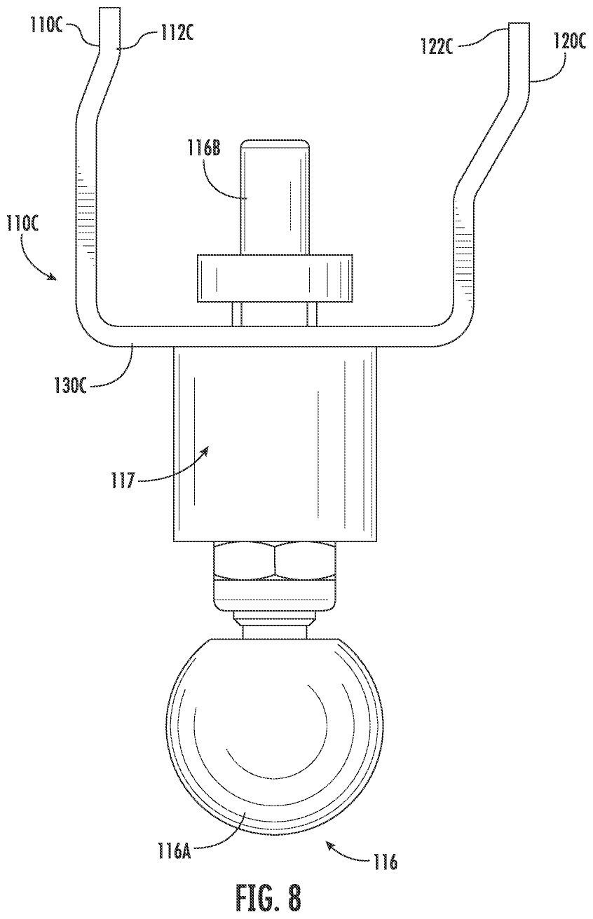

With reference to FIGS. 7A-8, another embodiment of the shuttle stopper 100C is shown having substantially the same overall operational purpose and function within the shuttle stopper assembly as the other embodiments discussed herein while having an altered geometry and/or shuttle stopper pin configuration as discussed herein. Unless noted otherwise, the depicted embodiment of the shuttle stopper has the same structure and function as the other embodiments of the shuttle stopper 100C and is interchangeable, in whole or in any part or combination of parts (including properties of components), with the other embodiments discussed herein.

FIG. 7A depicts the axes 50, 55 defined by the device and the rail. In the embodiment depicted in FIG. 7A, the shuttle stopper 100C may rigidly secure to the rail with at least one threaded fastener 140C. In various embodiments, the rail 300 defines a center axis 50 that extends parallel to the direction of travel of a shuttle. The center axis 50 may be disposed along the midpoint of the rail when the is bilaterally symmetric, as depicted in FIG. 3A. In other embodiments, the center axis 50 may be defined by a mid-point of the position of a plane of a shuttle traversing along the rail. The center axis 50 may be defined by the plane that remains stationary when the shuttle is traversing between backwards and forwards on the rail. In various embodiments, the center axis 50 may be used to define a first distance and/or a second distance relative to the alignment portion 110C and/or the safety portion 120C, respectively. The first distance is equal to the lateral distance from the center axis 50 to the alignment surface 112C of the alignment portion 110C, and the second distance is equal to the distance from center axis 50 to the safety surface 122C of the safety portion 120C. The first distance is configured to be less than the second distance, such that a shuttle pin may correctly pass the safety portion 120C when in a correct position while contacting the alignment portion 110C when installed incorrectly (e.g., backwards). The first distance is further configured to be less than the length of the pin of the shuttle (e.g., pin 220 of shuttle 200 shown in FIGS. 1-5) and the second distance is configured to be greater than the length of the pin of the shuttle.

With further reference to FIG. 7A, in various embodiments, the shuttle stopper 100C, in an instance the shuttle stopper 100C is secured to the rail may define at least one additional axis 55. The additional axis 55 may be perpendicular to the center axis 50 of the rail and/or perpendicular to the direction of travel of a shuttle. The additional axis 55 may further intersect at least partially with the midpoint of the alignment portion 110C and the safety portion 120C. In various embodiments, a pin (not depicted) of a shuttle is configured to extend from a first lateral side parallel to the additional axis 55.

In the depicted embodiment, the alignment portion 110C is positioned on a first side of the rail 300 and angles inwardly towards the center axis 50 at its top end, such that the alignment surface 112C at the top end is closer to the center axis than a lower surface of the alignment portion. In the depicted embodiment, the alignment surface is contacting or extending at least partially over the rail 300. In various embodiments, the alignment portion 110C may comprise at least a portion that angles inwardly towards the center axis defined by a rail. The inwardly angle portion may reduce the measurement of the first distance of the shuttle stopper 100C in order to prevent a shuttle from advancing along the direction of travel when positioned backwards. The position of the alignment portion 110C and alignment surface 112C reduces the first distance from the center axis, allowing the alignment portion to at least partially contact a shuttle (e.g., pin) when positioned backwards. In the depicted embodiment, the safety portion 120C is positioned on a second side of the rail 300 and angles outwardly away from the center axis 50 at its top end. The position of the safety surface 122C increases the distance of the second distance from the center axis. The second distance allows for a shuttle (e.g., pin), when position correctly, to pass inwardly along the safety surface 122C. In some embodiments, the shuttle stopper 100C may be interchangeable with varying geometry to accommodate different size pins and/or shuttle stopper body shapes. In the embodiment depicted in FIGS. 7A-8, a longer pin can fit inside the safety surface 122C than in the embodiment of FIGS. 1-2.

In various embodiments, the inwardly angled portion of the alignment portion 110C may be the alignment surface 112C of the alignment portion 110C and may be disposed at a height that is an intersecting height for the pin. The inwardly angled portion of the alignment portion 110C may further prevent the shuttle from advancing along the direction of travel. Similarly, the outwardly angled portion of the safety portion 120C may define the safety surface 122C and may be disposed at a height that is an intersecting height for the pin. The outwardly angled portion of the safety portion 120C may allow for the shuttle (e.g., the pin) to pass inwardly thereof, in an instance in which the shuttle is positioned correctly on the rail. In some embodiments, the lowermost portions of the shuttle stopper 100C may be the same width as the rail to align the shuttle stopper with the rail.

In various embodiments (including the embodiments of FIGS. 1-2, 6A-8), the shuttle stopper 100 (e.g., shuttle stoppers 100A, 100B, 100C) may consist of a single piece of rigid material (e.g., steel, aluminum, etc.) configured to withstand the forces applied to the shuttle stopper without deflecting sufficiently far to allow the pin to pass the alignment portion 110 in an incorrect position. In various embodiments, the attachment portion 130C may comprise at least one fastener opening 132C to receive at least one fastener threaded 140C (depicted in FIG. 7A) to secure the shuttle stopper to the rail. The shuttle stopper 100 may comprise a plurality of openings spaced evenly apart to further secure the shuttle stopper 100 to the rail.

With reference to FIG. 8, a front perspective view of the shuttle stopper 100C in accordance with various embodiments of the present disclosure. In the depicted embodiment, the shuttle stopper 100C comprises a shuttle stopper pin 116 disposed along the attachment portion 130C. The shuttle stopper pin 116 is depicted in a vertical position, and the pull portion 116A is disposed beneath the lowermost surface of the attachment portion 130C. In various embodiments, the pin body portion 116B may at least partially engage with an example shuttle preventing the shuttle from advancing along the direction of travel.

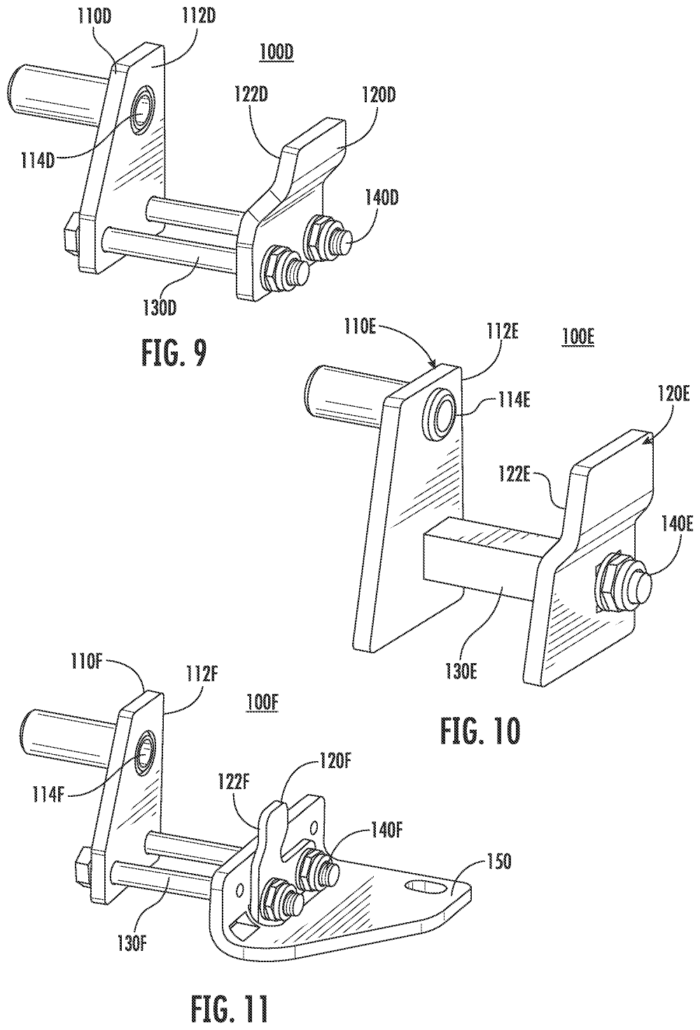

With reference to FIGS. 9-11, various embodiments of the shuttle stopper are shown having multiple components in accordance with various embodiments of the present disclosure. The embodiments shown in FIGS. 9-11 have substantially the same overall operational purpose and function within the shuttle stopper assembly as the other embodiments discussed herein while having an altered geometry and/or structure as discussed herein. Unless noted otherwise, the depicted embodiment of the shuttle stopper has the same structure and function as the other embodiments of the shuttle stopper 100 and is interchangeable, in whole or in any part or combination of parts (including properties of components), with the other embodiments discussed herein.

In the embodiment depicted in FIG. 9, the shuttle stopper 100D comprises an alignment portion 110D, a safety portion 120D, and an attachment portion 130D each shown as separate components. In the depicted embodiments, the individual portions may be separate from each other and secured with at least one threaded fastener 140D (e.g., nuts and bolts, which form the attachment portion 130D) to create the shuttle stopper 100D. In various embodiments, the alignment portion may define an alignment surface 112D and/or an opening 114D which functions similar to the other embodiments discussed herein. The alignment portion 110D may define a greater height than the safety portion 120D. In various embodiments, the alignment surface 112D defines the first distance perpendicular to the center axis 50 of the rail. The opening 114D is disposed in the alignment portion 110D and extends perpendicular to the center axis and is configured to receive a shuttle stopper pin 116 similar to the other embodiments disclosed herein.

With further reference to FIG. 9, in various embodiments, the safety portion 120D of the shuttle stopper 100D defines a safety surface 122D, wherein similar to the embodiment of FIGS. 7A-8, the safety surface 122D is angled outwardly away from the center axis of the rail. The safety portion 120D may comprise at least partially a portion that angles outwardly away from the center axis of the rail. The outwardly angled portion of the safety portion 120D may comprise the safety surface 122D and may be configured to pass outwardly of a pin of a shuttle oriented correctly on the rail. The safety surface 122D increases the distance of the second distance such that the second distance is greater than the width of the shuttle (e.g., pin length). The outwardly angled portion (e.g., safety surface 122D) of the safety portion 120D is disposed at an intersecting height of a pin of a shuttle. In the depicted embodiment, the alignment portion 110D includes a purely vertical inner surface (e.g., including alignment surface 112D), and in some embodiments, the alignment portion 110D may be angled inwardly similar to the embodiment of FIGS. 7A-8.

In the depicted embodiments, the attachment portion 130D may be defined by the at least one threaded fastener 140D. The threaded fasteners 140D are configured to extend through the alignment portion 110D and/or the safety portion, wherein the treaded fasteners 140D secure with a nut. In various embodiments, the uppermost surface of the treaded fasteners 140D may contact the lowermost surface of the rail, such that the shuttle stopper 100D secures to the rail via a clamping force between the alignment portion 110D and the safety portion 120D against the rail. In some embodiments, the threaded fastener 140D may be inserted through one or more opening defined by the rail, wherein the threaded fasteners secure at least partially to the rail.

With reference to the embodiment of FIG. 10, the structures and functions of the alignment portion 110E, the alignment surface 112E, the opening 114E, the safety portion 120E, and the safety surface 122E of the shuttle stopper 100E are substantially similar to the description for FIG. 9. In the depicted embodiments, the attachment portion 130E may be defined by at least one threaded fastener 140E (e.g., bolt and nut assembly) and a central rectangular prism that defines a fixed width of the shuttle stopper (e.g., rather than the cylindrical bolt(s) of FIG. 9). In various embodiments, the uppermost surface of the attachment portion 130E may contact the lowermost surface of the rail (e.g., rail 300 shown in FIGS. 1-2), such that the shuttle stopper 100E secures to the rail via a clamping force between the alignment portion 110E and the safety portion 120E with the rail. In some embodiments, at least a part of the attachment portion 130E may be inserted through one or more opening defined by the rail. In the depicted embodiments, at least a portion of the alignment portion 110E and/or the safety portion 120E may extend beneath the lowermost surface of the attachment portion 130E.

With reference to the embodiment of FIG. 11, the structures and functions of the alignment portion 110F, the alignment surface 112F, the opening 114F, the attachment portion 130F, and the at least one treaded fastener 140F of the shuttle stopper 100F are substantially the same as the embodiment of FIG. 9. In the depicted embodiments, the safety portion 120F of the shuttle stopper 100F may comprise an additional bracket portion 150. The bracket portion 150 provides an additional buffer distance and stabilizing surface between the safety portion 120F and the rail. The thickness of the material of the bracket portion 150 increases the distance from the safety surface 122F of the safety portion 120F to the center axis, which may be accommodated by narrowing the outward angle of the upper portion of the safety portion 120F. The bracket portion 150 may be used to further secure the shuttle stopper 100F to a rail and/or both the shuttle stopper and the rail to an additional attachment surface (e.g., wall, additional rail, beam, etc.). In some embodiments, the safety surface 122F of the safety portion may be disposed vertically beneath the opening 114F defined by the alignment portion 110F. The safety surface 122F is disposed at an intersecting height of a pin of a shuttle allowing for the shuttle to pass inwardly past the safety portion 120F, in an instance in which the shuttle is positioned correctly on the rail.

Many modifications and other embodiments of the present disclosure set forth herein will come to mind to one skilled in the art to which this disclosure pertains having the benefit of the teachings presented in the foregoing description and the associated drawings. Therefore, it is to be understood that the present disclosure is not to be limited to specific embodiments disclosed and that modifications and other embodiments are intended to be included within the scope of the appended claims. Moreover, although the foregoing description and the associated drawings describe example embodiments in the context of certain example combination of elements and/or functions, it should be appreciated, in light of the present disclosure, that different combinations of elements and/or functions than those explicitly described above are also contemplated as can be set forth in some of the appended claims. Although specific terms are employed herein, they are used in a generic and descriptive sense only and not for purpose of limitation.

1. A shuttle stopper configured to be attached to a rail to facilitate alignment of a shuttle with the rail, the shuttle stopper comprising:
an alignment portion defining an alignment surface configured to face inwardly towards a center axis of the rail, the alignment surface defining a first distance to the center axis; and
a safety portion defining a safety surface configured to face inwardly towards the center axis of the rail on an opposite side of the center axis from the alignment surface, the safety surface defining a second distance to the center axis,
wherein the second distance is greater than the first distance, and
wherein the shuttle stopper, including the alignment portion and the safety portion, is configured to rigidly attach to the rail.

2. The shuttle stopper of claim 1, wherein the shuttle stopper further comprises an attachment portion configured to secure the shuttle stopper to the rail.

3. The shuttle stopper of claim 1, wherein the alignment surface and the safety surface are configured intersect a height of a pin of the shuttle, the height configured to be defined perpendicular to a direction of travel of the shuttle.

4. The shuttle stopper of claim 1, wherein the second distance is configured to be greater than a pin distance of the shuttle, such that, the pin distance is measured from the center axis of the rail to a top of a pin of the shuttle.

5. The shuttle stopper of claim 1, wherein the safety surface is configured to permit a pin of the shuttle to pass inwardly of the safety surface in an instance in which the shuttle is in a correctly installed position on the rail.

6. The shuttle stopper of claim 1, wherein the alignment portion is configured to engage with at least a portion of the shuttle in an instance in which the shuttle is positioned backwards on the rail.

7. A shuttle stopper assembly configured to be attached to a rail to facilitate alignment of a shuttle with the rail, the shuttle stopper assembly comprising:
the shuttle stopper of claim 1; and
the shuttle comprising a pin, wherein the shuttle defines a direction of travel along the center axis of the rail, and wherein the pin is disposed at a first lateral side of the shuttle.

8. A shuttle stopper assembly configured to be attached to a rail to facilitate alignment of a shuttle with the rail, the shuttle stopper assembly comprising:
a shuttle stopper comprising:
an alignment portion defining an alignment surface configured to face inwardly towards a center axis of the rail, the alignment surface defining a first distance to the center axis;
a safety portion defining a safety surface configured to face inwardly towards the center axis of the rail on an opposite side of the center axis from the alignment surface, the safety surface defining a second distance to the center axis,
wherein the second distance is greater than the first distance, and
wherein the shuttle stopper, including the alignment portion and the safety portion, is configured to rigidly attach to the rail; and
the rail, wherein the rail defines the center axis.

9. The shuttle stopper assembly of claim 8, wherein the shuttle stopper further comprises an attachment portion configured to secure the shuttle stopper to the rail.

10. The shuttle stopper assembly of claim 9, wherein the attachment portion is further configured to define an axis of the shuttle stopper, wherein the axis is parallel to the center axis of the rail, and wherein the alignment surface and safety surface each define planes parallel to the axis of the shuttle stopper.

11. The shuttle stopper assembly of claim 8, further comprises a shuttle comprising a pin, wherein the shuttle defines a direction of travel along the center axis of the rail, and wherein the pin is disposed at a first lateral side of the shuttle.

12. The shuttle stopper assembly of claim 11, wherein the pin protrudes from the first lateral side of the shuttle in a direction perpendicular to the direction of travel of the shuttle.

13. The shuttle stopper assembly of claim 11, wherein the alignment surface and the safety surface are configured intersect a height of the pin of the shuttle, the height is measured perpendicular to a direction of travel of the shuttle.

14. The shuttle stopper assembly of claim 11, wherein the second distance is greater than a pin distance of the shuttle, wherein the pin distance is measured from the center axis of the rail to an end of a pin of the shuttle.

15. The shuttle stopper assembly of claim 14, wherein the pin of the shuttle is configured to pass inwardly of the safety surface in an instance in which the shuttle is in a correctly installed position on the rail.

16. The shuttle stopper assembly of claim 15, wherein the alignment portion is configured to engage with at least a portion of the shuttle, in an instance in which the shuttle is positioned backwards on the rail.

17. A method of operating a shuttle with a rail having a shuttle stopper, the method comprising:
sliding a shuttle along a rail, the rail having a shuttle stopper comprising:
an alignment portion defining an alignment surface configured to face inwardly towards a center axis of the rail, the alignment surface defining a first distance to the center axis; and
a safety portion defining a safety surface configured to face inwardly towards the center axis of the rail on an opposite side of the center axis from the alignment surface, the safety surface defining a second distance to the center axis,
wherein the second distance is greater than the first distance,
wherein the shuttle stopper, including the alignment portion and the safety portion, is configured to rigidly attach to the rail, and
wherein a pin of the shuttle is configured to pass inwardly of the safety surface, in an instance in which the shuttle is in a correctly installed position on the rail.

18. The method of claim 17, wherein the alignment surface and the safety surface are configured intersect a height of a pin of the shuttle, the height configured to be defined perpendicular to a direction of travel of the shuttle.

19. The method of claim 17, wherein the second distance is configured to be greater than a pin distance of the shuttle, such that, the pin distance is measured from the center axis of the rail to a top of a pin of the shuttle.

20. The method of claim 17, wherein the safety surface is configured to permit a pin of the shuttle to pass inwardly of the safety surface in an instance in which the shuttle is in a correctly installed position on the rail, and wherein the alignment portion is configured to engage with at least a portion of the shuttle in an instance in which the shuttle is positioned backwards on the rail.
